(19) United States
(12) Patent Application Publication
(10) Pub. No.: US 2025/0387899 A1
(43) Pub. Date: Dec. 25, 2025

(54) ROBOT CONTROL DEVICE, ROBOT, AND ROBOT CONTROL METHOD

(71) Applicant: CASIO COMPUTER CO., LTD., Tokyo (JP)

(72) Inventors: Kouki MAYUZUMI, Tokyo (JP); Hirokazu HASEGAWA, Tokyo (JP)

(73) Assignee: CASIO COMPUTER CO., LTD., Tokyo (JP)

(21) Appl. No.: 19/242,515

(22) Filed: Jun. 18, 2025

(30) Foreign Application Priority Data
Jun. 24, 2024 (JP) 2024-100974

(51) Int. Cl. B25J 9/00; A63H 3/00; B25J 11/00

(52) U.S. Cl. CPC B25J 9/0003; A63H 3/001; B25J 11/0005

(57) ABSTRACT

A robot control device includes one or more processors configured to cause a robot to perform processing corresponding to an external stimulus detected by a sensor. The one or more processors disable the robot from performing processing corresponding to the external stimulus detected by the sensor, stop the sensor from detecting the external stimulus, or decrease a detection sensitivity of the external stimulus by the sensor, depending on a type of a gesture being currently performed by the robot.

### CROSS-REFERENCE TO RELATED APPLICATIONS

This application claims priority and benefit of Japanese Patent Application No. 2024-100974, filed on Jun. 24, 2024, the entire contents, including the description, claims and drawings of which are incorporated herein by reference.

### TECHNICAL FIELD

The present disclosure relates to a robot control device, a robot, and a robot control method.

### BACKGROUND ART

There is known a technique of causing a robot to perform predetermined reaction motions in response to external stimuli, such as a call by a user (e.g., Japanese Unexamined Patent Application No. 2003-326479).

### SUMMARY OF THE INVENTION

According to the present disclosure, there is provided a robot control device comprising one or more processors configured to: cause a robot to perform processing corresponding to an external stimulus detected by a sensor, and (i) disable the robot: from performing processing corresponding to the external stimulus detected by the sensor, (ii) stop the sensor from detecting the external stimulus, or (iii) decrease a detection sensitivity of the external stimulus by the sensor, depending on a type of a gesture being currently performed by the robot.

### BRIEF DESCRIPTION OF DRAWINGS

FIG. 1 illustrates an external appearance of a robot.

FIG. 2 is a schematic diagram illustrating a configuration of a main body of the robot.

FIG. 3 is a block diagram illustrating a functional configuration of the robot.

FIG. 4 is a schematic cross-sectional view of the robot housed in a power feeder.

FIG. 5 is a diagram for explaining groups of external stimuli.

FIG. 6 is a flowchart of a control procedure of a motion control process.

FIG. 7 is a flowchart of a control procedure of a reaction gesture determination process.

FIG. 8 is a time chart illustrating an example of motions of the robot when no external stimuli occur.

FIG. 9 is a time chart illustrating an example of motions of the robot when external stimuli occur.

### DETAILED DESCRIPTION

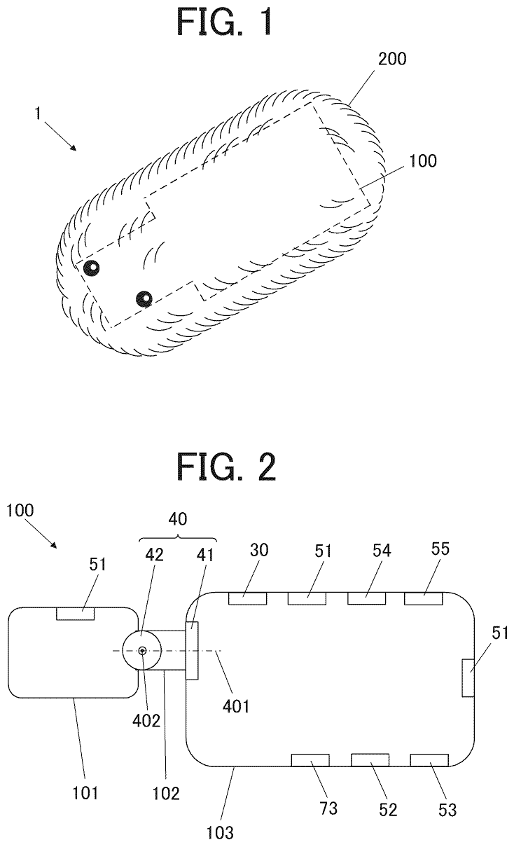

Hereinafter, an embodiment of the present disclosure is described with reference to the figures. As illustrated in FIG. 1, a robot 1 includes a main body 100 and an exterior 200 that covers the main body 100. The robot 1 is a pet robot that imitates a small creature. The robot 1 can make multiple motions imitating gestures of a creature. The exterior 200 changes its form according to the motions of the main body 100. The exterior 200 includes fur made of a pile weave and decorative members representing eyes. The robot 1 is equipped with artificial intelligence (AI). The robot 1 has learning functions, such as increasing the variety of motions and improving its ability to communicate with a user.

As illustrated in FIG. 2, the main body 100 of the robot 1 includes a head 101, a body 103, and a connection part 102 that connects the head 101 and the body 103. In the following, the part of the robot 1 corresponding to the head 101 may also be called the “neck”. The body 100 includes a drive unit 40 for moving the head 101 with respect to the body 103. The drive unit 40 includes a twist motor 41 and an up-down movement motor 42. The twist motor 41 is a servomotor that rotates the head 101 and the connection part 102 within a predetermined range of angles on a first rotation axis 401 extending in the direction in which the connection part 102 extends. By the operation of the twist motor 41, the robot 1 makes a motion of twisting its neck. The up-down movement motor 42 is a servomotor that rotates the head 101 on a second rotation axis 402 perpendicular to the first rotation axis 401 within a predetermined range of angles. By the up-down movement motor 42, the robot 1 makes a motion of raising and lowering its head. The direction of the up-down movement of the head may be inclined with respect to the vertical direction, depending on the angle of the head twisted by the twist motor 41. By periodic small movements of the twist motor 41 and/or the up-down movement motor 42, the robot 1 makes motions of rocking its neck or trembling. The timing, the magnitude, and the speed of movements of the twist motor 41 and the up-down movement motor 42 can be appropriately adjusted and combined to cause the robot 1 to perform various behaviors, such as a pleased gesture, a startled gesture, and a breathing gesture imitating breathing of a living creature, for example.

The main body 100 includes touch sensors 51, an acceleration sensor 52, a gyro sensor 53, an illuminance sensor 54, a microphone 55, a sound output unit 30, and a power receiving coil 73. The touch sensors 51 are provided at the upper part of the head 101 and the upper and lateral parts of the body 103, for example. The touch sensor 51 may also be provided at the connection part 102. The illuminance sensor 54, the microphone 55, and the sound output unit 30 are provided at the upper part of the body 103. The acceleration sensor 52 and the gyro sensor 53 are provided at the lower part of the body 103. The power receiving coil 73 is provided near the bottom surface of the body 103.

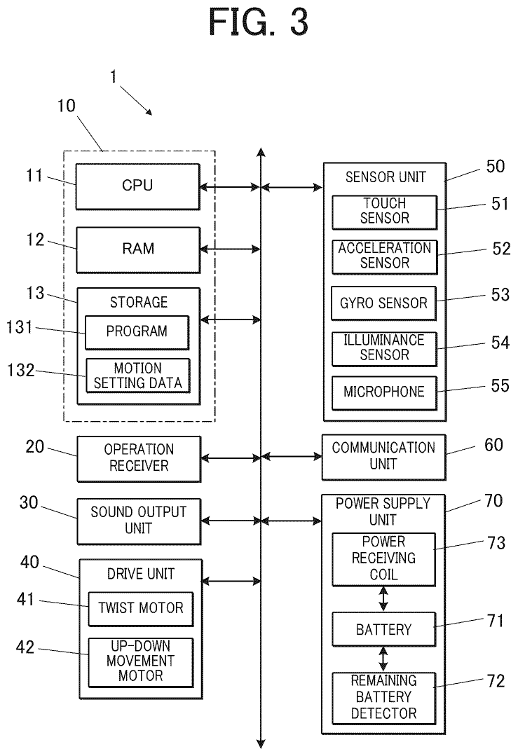

As illustrated in FIG. 3, the robot 1 includes a central processing unit (CPU) 11, a random-access memory (RAM) 12, a storage 13, an operation receiver 20, the sound output unit 30, the drive unit 40, a sensor unit 50, a communication unit 60, and a power supply unit 70. The components of the robot 1 are connected via a communication path, such as a bus. All the functional components shown in FIG. 3 are provided to the main body 100. The CPU 11, the RAM 12, and the storage 13 constitute a robot control device 10 that controls motions of the robot 1.

The CPU 11 is a processor that reads and executes a program 131 stored in the storage 13 and performs various arithmetic operations to control motions of the robot 1. The robot 1 may include multiple processors (e.g., multiple CPUs). Multiple processes executed by the CPU 11 in this embodiment may be executed by the multiple processors. In this case, the processor is composed of multiple processors. The multiple processors may be involved in the same process(es) or independently perform different processes in parallel. The RAM 12 provides the CPU 11 with a working memory space and stores temporary data.

The storage 13 is a non-transitory recording medium readable by the CPU 11 as a computer and stores the program 131 and various kinds of data. The storage 13 includes a nonvolatile memory, such as a flash memory, for example. The program 131 is stored in the storage 13 in the form of a computer-readable program code. The data stored in the storage 13 includes motion setting data 132. The motion setting data 132 contains contents of motions by the robot 1, such as (i) processing (reaction gestures) to be performed by the robot 1 according to the state of the robot 1 or the contents of external stimuli and (ii) spontaneous gestures to be performed spontaneously by the robot 1 without external stimuli. The setting for the contents of motions includes (i) setting for timing and the movement amount of the twist motor 41 and the up-down movement motor 42 of the drive unit 40 and (ii) setting of the pitch (height), length, and volume of sound output by the sound output unit 30, for example. The motion setting data 132 contains predetermined conditions associated with gestures that are performed when the predetermined conditions are met.

The operation receiver 20 includes an operation button(s) and an operation knob(s) for turning on/off the power and adjusting the volume of sound output by the sound output unit 30. The operation receiver 20 outputs operation information to the CPU 11 corresponding to operations input to the operation button and the operation knob. The sound output unit 30 includes a speaker and outputs sound at a pitch (height), length, and volume in accordance with control signals and sound data sent by the CPU 11. The sound output unit 30 may output a sound imitating a cry (call) of a living creature. The drive unit 40 operates the twist motor 41 and the up-down movement motor 42 in accordance with control signals sent by the CPU 11.

The sensor unit 50 includes the touch sensor 51, the acceleration sensor 52, the gyro sensor 53, the illuminance sensor 54, and the microphone 55 described above. The sensor unit 50 outputs detection results of the sensors and the microphone 55 to the CPU 11. The touch sensor 51, the acceleration sensor 52, the gyro sensor 53, the illuminance sensor 54, and the microphone 55 correspond to “sensors that detect an external stimulus”. The touch sensor 51 detects contact between the robot 1 and a user or an object. The touch sensor 51 includes, for example, a pressure sensor or a capacitance sensor. The touch sensor 51 outputs detection data indicating whether the robot 1 is contacted (touched) to the CPU 11. If the touch sensor 51 includes a pressure sensor, the touch sensor 51 also outputs the intensity of the contact with the robot 1 to the CPU 11. The acceleration sensor 52 detects acceleration in the respective three axes perpendicular to each other and outputs the detected data to the CPU 11. The gyro sensor 53 detects angular velocities around the respective three perpendicular axes and outputs the detected data to the CPU 11. The illuminance sensor 54 detects brightness around the robot 1 and outputs the detected data to the CPU 11. The microphone 55 detects sounds around the robot 1 and outputs the detected sound data to the CPU 11. The sensor unit 50 may include a sensor that detects a press of the power button of the operation receiver 20.

The communication unit 60 is a communication module that includes an antenna, a modulation-demodulation circuit, and a signal processing circuit. The communication unit 60 performs wireless data communication with external devices in accordance with a predetermined communication protocol.

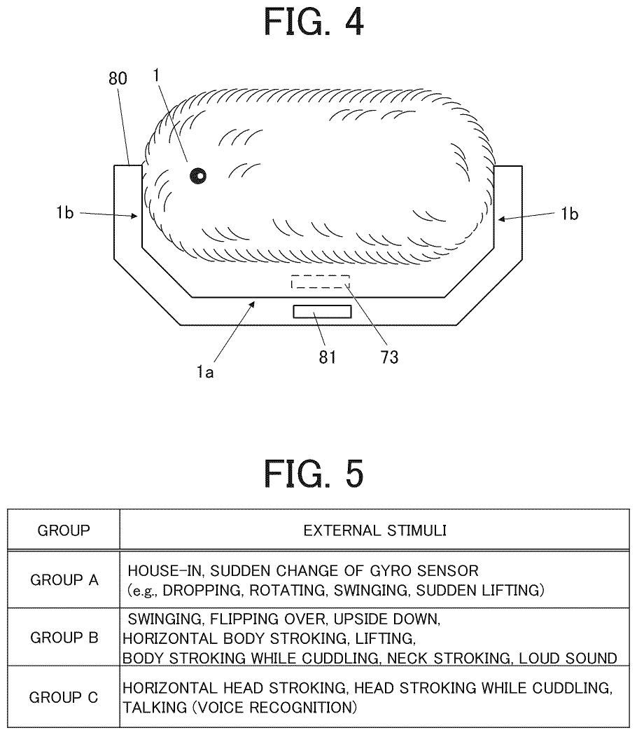

The power supply unit 70 includes a battery 71, a remaining battery detector 72, and the power receiving coil 73. The battery 71 supplies power to the components of the robot 1. The battery 71 in this embodiment is a secondary battery that is repeatedly rechargeable by a non-contact recharging method. The remaining battery detector 72 detects the remaining battery level of the battery 71 in accordance with control signals sent by the CPU 11 and outputs the detection result to the CPU 11. As illustrated in FIG. 4, the charging operation of the battery 71 is performed in a state where the robot 1 is housed (set) in a dedicated power feeder 80 (housing, charging dock). FIG. 4 illustrates a cross section of the power feeder 80 and a side view of the robot 1 for convenience of explanation. The external appearance of the power feeder 80 resembles a house of the robot 1. The power feeder 80 is a h housing that has approximately the same length and width as the external form of the robot 1. The power feeder 80 has an opening at the top, and the robot 1 can be inserted and removed through the opening. The power feeder 80 is formed such that the power feeder 80 can be in contact with the bottom surface 1a and at least part of the lateral surface 1b of the robot 1 when the robot 1 is housed. At the bottom of the power feeder 80, a power sending coil 81 is provided at a position opposite the power receiving coil 73 when the robot 1 is housed. When the power feeder 80 detects the housed robot 1, the power feeder 80 sends current to the power sending coil 81 to generate a magnetic field. The power receiving coil 73 of the robot 1 supplies current generated by electromagnetic induction of the magnetic field to the battery 71. With such a configuration, the charging operation of the battery 71 automatically starts when the robot 1 is housed in the power feeder 80. The method of charging the battery 71 is not limited to a non-contact charging method but may be a contact charging method. In a contact charging method, a charging terminal of the robot 1 is brought into contact with a charging terminal of the power feeder 80.

Next, the gestures of the robot 1 are described. When an external stimulus is detected by the sensor unit 50, the CPU 11 causes the robot 1 to perform processing (a reaction gesture) corresponding to the detected external stimulus. Examples of the external stimuli include changes in the state of the robot 1 detected by the touch sensor 51, the acceleration sensor 52, the gyro sensor 53, and so forth, brightness around the robot 1 detected by the illuminance sensor 54, and sound around the robot 1 detected by the microphone 55. The reaction gestures include motions by the drive unit 40 and cries (calls) output by the sound output unit 30.

When the CPU 11 detects a change in the state of the robot 1 (e.g., contact, movement, or orientation) as an external stimulus, the CPU 11 causes the robot 1 to perform a predetermined reaction gesture that is registered beforehand in the motion setting data 132. The CPU 11 detects the state of the robot 1, based on detection signals from the touch sensor 51, the acceleration sensor 52, and the gyro sensor 53. Examples of the state of the robot 1 include the state where the robot 1 is lifted, the state where the robot 1 is held (cuddled), and the state where the robot 1 is being stroked (patted).

When the CPU 11 detects a loud sound as an external stimulus, the CPU 11 causes the robot 1 to perform a startled reaction gesture that is registered beforehand in the motion setting data 132. The CPU 11 determines that a loud sound is detected when the microphone 55 detects a sound louder than a predetermined value.

When the CPU 11 detects the voice of the user talking to the robot 1 as an external stimulus (hereinafter called “talking voice”), the CPU 11 causes the robot 1 to perform a pleased response gesture that is registered beforehand in the motion setting data 132. The CPU 11 determines that a talking voice is detected when the microphone 55 detects a sound within a predetermined volume range. The CPU 11 may determine that a talking voice is detected by voice recognition of sound data detected by the microphone 55. Voice recognition is not limited to recognizing contents of talks but may be simply recognizing that the sound is a human voice. The CPU 11 may distinguish voices of individual users so that the robot 1 responds only to a user(s) who is the owner of the robot 1.

When the CPU 11 detects that the robot 1 is housed in the power feeder 80 (the housed state, house-in) as an external stimulus, the CPU 11 causes the robot 1 to perform a predetermined response gesture that is registered beforehand in the motion setting data 132. When the power supply unit 70 is charging the battery 71 using the power receiving coil 73, the CPU 11 determines that the robot 1 is housed in the power feeder 80. When the power supply unit 70 is not performing the charging operation of the battery 71, the CPU 11 determines that the robot 1 is outside the power feeder 80 (a not-housed state). The CPU 11 may use other methods to determine whether the robot 1 is in the housed state. For example, the sensor unit 50 may include a sensor configured to detect that the robot 1 is housed in the power feeder 80, and the CPU 11 may determine whether the robot 1 is in the housed state, based on the detection result of the sensor.

When conditions for performing a spontaneous gesture are met, the CPU 11 causes the robot 1 to perform a predetermined spontaneous gesture registered in the motion setting data 132 even when no external stimuli occur. The conditions for performing a spontaneous gesture may include a condition that no external stimuli occur for a predetermined period, for example. The conditions are not limited thereto. There may be multiple spontaneous gestures registered, and the CPU 11 may cause the robot 1 to perform a motion randomly selected from the multiple spontaneous gestures. As one of the spontaneous gestures, the CPU 11 causes the robot 1 to repeat a breathing gesture at a predetermined frequency. This makes the robot 1 look more lifelike. The spontaneous gestures except the breathing gesture are referred to as “auto-generated motion gestures”. That is, the spontaneous gestures are either the breathing gesture or the auto-generated motion gestures. Examples of the auto-generated motion gestures include a gesture of tilting the head, a gesture of shaking, and a gesture of being at rest.

Next, an overview of the present disclosure is described. The CPU 11 keeps obtaining sensor values from the sensor unit 50 to respond to user operations (touch or talking) while the robot 1 is making a gesture. In causing the robot 1 to execute processing corresponding to an external stimulus, the CPU 11 may disable the robot 1 from executing processing corresponding to the external stimulus detected by the sensor (e.g., the sensor unit 50), depending on the type of gesture currently performed by the robot 1.

The CPU 11 determines whether to cause the robot 1 to execute processing corresponding to an external stimulus, based on a group to which the external stimulus belongs. FIG. 5 shows an example of external stimuli belonging to their respective groups when external stimuli are classified into the groups. The external stimuli belonging to Group A are the stimuli that do not occur without conscious manipulation by the user. The robot 1 should always respond to the external stimuli belonging to Group A. Group A includes house-in (housing the robot 1 in the power feeder 80) and sudden changes of the gyro sensor 53. Causes of sudden changes of the gyro sensor 53 include dropping, rotating, swinging, or sudden lifting of the robot 1.

The external stimuli belonging to Group B are the stimuli that may be wrongly detected when the robot 1 is making gestures involving a relatively large amount of motions. The external stimuli belonging to Group B are less likely to be wrongly detected while the robot 1 is making the breathing gesture or auto-generated motion gestures, which involve a relatively small amount of motions. Therefore, the CPU 11 causes the robot 1 to execute processing corresponding to the external stimuli belonging to Group B only when the robot 1 is making the breathing gesture or the auto-generated motion gestures or when the robot 1 is not making any gesture. On the other hand, to prevent wrong detection, the CPU 11 does not cause the robot 1 to execute processing corresponding to the external stimuli belonging to Group B while the robot 1 is performing a gesture other than the breathing gesture and the auto-generated motion gestures. Group B includes swinging, flipping over, upside down, horizontal body stroking, lifting, body stroking while cuddling, neck stroking, and loud sound. Swinging is the rotation of the head 101 and the body 103 on the first rotation axis 401 as the center. Flipping over is an action of directing the belly side (bottom surface) of the body 103 of the robot 1 vertically upward. Upside down is an action of directing the head 101 of the robot 1 vertically downward. Horizontal body stroking is an action of the user stroking the body 103 of the robot 1 in the state where the belly side of the body 103 faces vertically downward. Lifting is an action of the user lifting the robot 1 by hand(s). Body stroking while cuddling is an action of the user stroking the body 103 while cuddling the robot 1. Neck stroking is an action of the user stroking the connection part 102 of the robot 1.

The external stimuli belonging to Group C are the stimuli that are more likely to be wrongly detected than the external stimuli belonging to Group B. The touch sensor 51 provided to the head 101 of the robot 1 may detect contact when the fur (exterior 200) is shifted or rubbed during motor operations. Therefore, the CPU 11 causes the robot to execute processing corresponding to “head stroking” only when the robot 1 is making the breathing gesture, which involves a very small amount of motions, or when the robot 1 is not making any gesture. The CPU 11 also performs voice recognition and learns the user's voice when the average value of the volume (dB) in a certain period is within a predetermined range. While the motor is in operation, the microphone 55 may pick up the operation sound of the robot 1 itself, and the average value of the sound volume in a certain period may fall within a predetermined range. Therefore, the CPU 11 enables a reaction gesture corresponding to talking only when the robot 1 is making the breathing gesture or not making any gesture. Group C includes horizontal head stroking, head stroking while cuddling, and talking (voice recognition). Horizontal head stroking is an action of the user stroking the head 101 of the robot 1 in the state where the belly side of the body 103 faces vertically downward. Head stroking while cuddling is an action of the user stroking the head 101 while cuddling the robot 1.

When the robot 1 is making a spontaneous gesture, the CPU 11 may cause the robot 1 to execute processing corresponding to an external stimulus. When the robot 1 is making a gesture other than the spontaneous gestures, the CPU 11 may not cause the robot 1 to execute processing corresponding to an external stimulus. In determination on whether the robot 1 is making a spontaneous gesture, the spontaneous gesture may be limited to the breathing gesture imitating breathing.

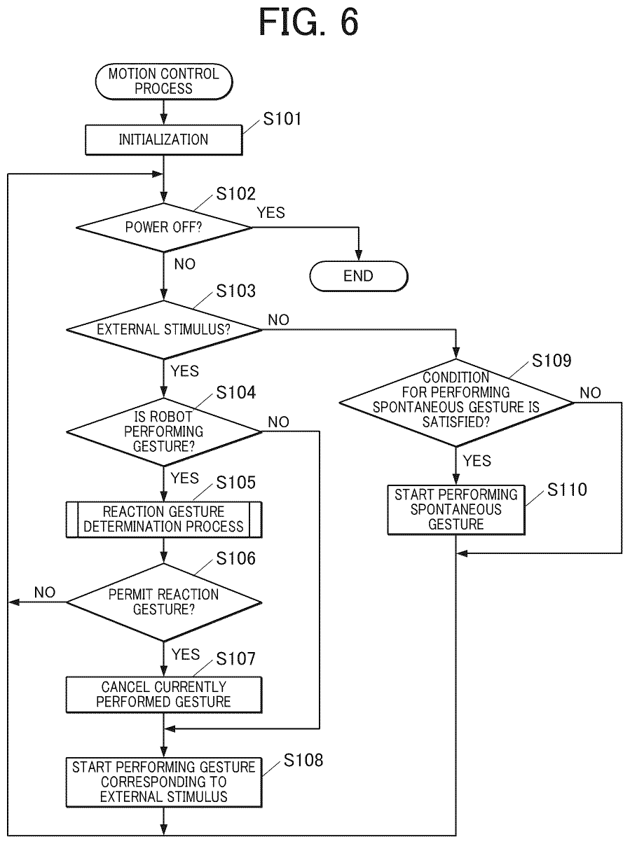

Next, a motion control process to be executed by the CPU 11 is described with reference to FIG. 6. The motion control process starts when the robot 1 is turned on (the power button is pressed) and activated. When the motion control process starts, the CPU 11 initializes each part of the robot 1 (step S101). Next, the CPU 11 determines whether the user has made an operation of turning off the robot 1 with the operation receiver 20 (whether the user presses the power button) (step S102). When determining that the user has not made an operation of turning off the robot 1 (step S102: NO), the CPU 11 determines whether an external stimulus has been detected, based on the detection results by the sensors of the sensor unit 50 and so forth (step S103). When determining that an external stimulus has been detected (step S103: YES), the CPU 11 determines whether the robot 1 is currently making a gesture (step S104). When determining that the robot 1 is currently making a gesture (step S104: YES), the CPU 11 executes a reaction gesture determination process (Step S105).

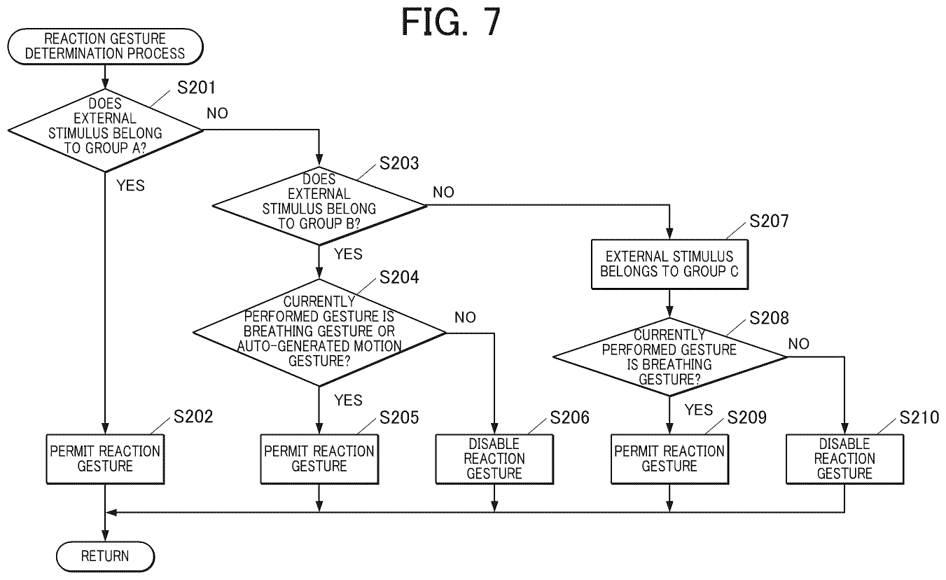

As shown in FIG. 7, in the reaction gesture determination process, the CPU 11 determines whether the detected external stimulus belongs to group A (see FIG. 5) (step S201). When determining that the detected external stimulus belongs to group A (step S201: YES), the CPU 11 permits execution of a response gesture corresponding to the external stimulus, regardless of the gesture being currently performed by the robot 1 (currently performed gesture) (Step S202).

When determining in step S201 that the detected external stimulus does not belong to group A (step S201: NO), the CPU 11 determines whether the detected external stimulus belongs to group B (see FIG. 5) (step S203). When determining that the detected external stimulus belongs to group B (step S203: YES), the CPU 11 determines whether or not the currently performed gesture is the breathing gesture or an auto-generated motion gesture (step S204). When determining that the currently performed gesture is the breathing gesture or an auto-generated motion gesture (step S204: YES), the CPU 11 permits execution of a reaction gesture corresponding to the external stimulus (step S205). In step S204, when determining that the currently performed gesture is neither the breathing gesture nor an auto-generated motion gesture (step S204: NO), the CPU 11 disables execution of a reaction gesture corresponding to the external stimulus (step S206).

When determining in step S203 that the detected external stimulus does not belong to group B (step S203: NO), the CPU 11 determines that the detected external stimulus belongs to group C (see FIG. 5) (step S207). Next, the CPU 11 determines whether the currently performed gesture is the breathing gesture (step S208). When determining that the currently performed gesture is the breathing gesture (step S208: YES), the CPU 11 permits execution of a reaction gesture corresponding to the external stimulus (step S209). In step S208, when determining that the currently performed gesture is not the breathing gesture (step S208: NO), the CPU 11 disables execution of a reaction gesture corresponding to the external stimulus (step S210).

When any of steps S202, S205, S206, S209, and S210 ends, the CPU 11 ends the reaction gesture determination process and returns to the motion control process in FIG. 6. After step S105, the CPU 11 determines whether to permit execution of a reaction gesture corresponding to the external stimulus, based on the result of the reaction gesture determination process (step S106). When determining to permit execution of a reaction gesture corresponding to the external stimulus (step S106: YES), the CPU 11 cancels the gesture being currently performed by the robot 1 (step S107). After step S107 or when determining in step S104 that the robot 1 is not performing any gesture (step S104: NO), CPU 11 causes the robot 1 to start performing the reaction gesture corresponding to the external stimulus (step S108). Herein, the CPU 11 identifies the content of the reaction gesture corresponding to the external stimulus by referring to the motion setting data 132 and sends control signals for performing the identified gesture to the drive unit 40 and the sound output unit 30.

In step S103, when determining that no external stimulus has been detected (step S103: NO), the CPU 11 determines whether the condition for performing a spontaneous gesture is met (step S109). For example, the CPU 11 determines that the condition for performing a spontaneous gesture is met when no external stimuli have been received for a predetermined period. When determining that the condition for performing a spontaneous gesture is met (step S109: YES), the CPU 11 causes the robot 1 to start performing the spontaneous gesture (step S110). Herein, the CPU 11 identifies the content of the spontaneous gesture by referring to the motion setting data 132 and sends control signals for performing the identified gesture to the drive unit 40 and the sound output unit 30. For example, the CPU 11 causes the robot 1 to perform the breathing gesture or auto-generated motion gestures.

When either step S108 or S110 ends or when the CPU 11 determines “NO” in step S106 or S109, the CPU 11 returns to step S102. When determining in step S102 that the user has made an operation of turning off the robot 1 (step S102: YES), the motion control process ends. The power off may be included in Group A as an external stimulus from the user.

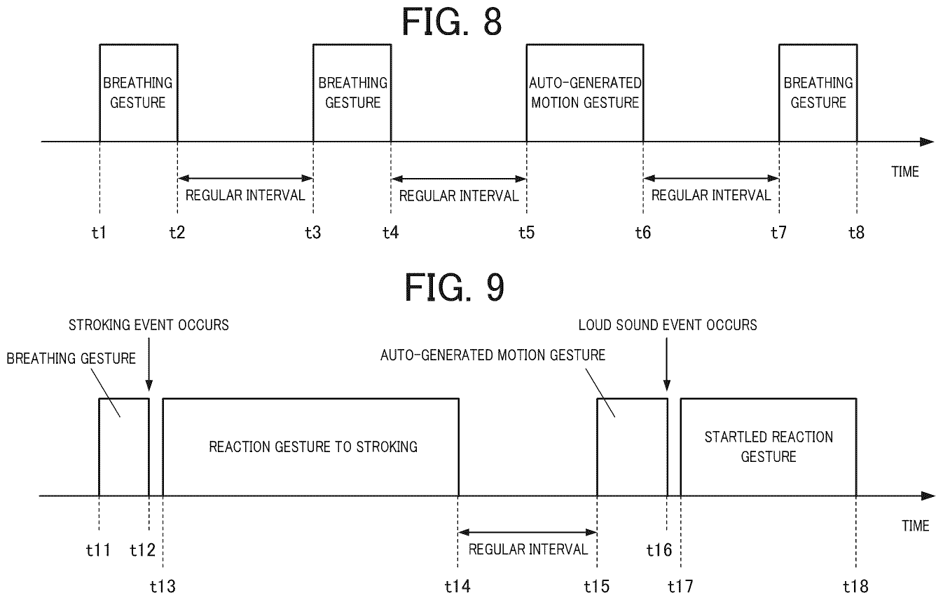

As shown in FIG. 8, when there are no external stimuli, the CPU 11 causes the robot 1 to perform the breathing gesture or the auto-generated motion gestures at a regular interval. In the example of FIG. 8, the CPU 11 causes the robot 1 to start performing the breathing gesture at time t1 and end the breathing gesture at time t2. The breathing gesture between time t1 and time t2 in FIG. 8 corresponds to “one breath”. After a regular interval from time t2, the CPU 11 causes the robot 1 to start performing the breathing gesture at time t3 and end the breathing gesture at time t4. After the regular interval from time t4, the CPU 11 causes the robot 1 to start performing an auto-generated motion gesture at time t5 and end the auto-generated motion gesture at time t6. After the regular interval from time t6, the CPU 11 causes the robot 1 to start performing the breathing gesture at time t7 and end the breathing gesture at time t8. The regular interval between spontaneous gestures (breathing gesture, auto-generated motion gestures) may be dynamically changed according to the charging state of the robot 1 or how tired the robot 1 is.

As shown in FIG. 9, an external stimulus may occur while the robot 1 is performing a gesture. In the example of FIG. 9, the CPU 11 causes the robot 1 to start performing the breathing gesture at time t11. Thereafter, while the robot 1 is performing the breathing gesture, the CPU 11 detects a “stroking event” at time t12. That is, based on the detection of contact by the touch sensor 51, the CPU 11 determines that the robot 1 was stroked by the user. The stroking events include horizontal body stroking, body stroking while cuddling, neck stroking, horizontal head stroking, and head stroking while cuddling. At time t12, the CPU 11 cancels (stops) execution of the breathing gesture by the robot 1. At time 13, the CPU 11 causes the robot 1 to start performing the reaction gesture corresponding to the stroking. At time 14, the CPU 11 causes the robot 1 to end the reaction gesture corresponding to the stroking. After the regular interval from time t14, the CPU 11 causes the robot 1 to start performing an auto-generated motion gesture at time t15. At time t16 while the robot 1 is performing the auto-generated motion gesture, the CPU 11 detects a “loud sound event”. That is, the CPU 11 determines that a loud sound has occurred, based on the detection of a sound louder than a predetermined value by the microphone 55. At time t16, the CPU 11 cancels (stops) the execution of the auto-generated motion gesture by the robot 1. At time t17, the CPU 11 causes the robot 1 to start performing a startled reaction gesture (reaction gesture corresponding to a loud sound). At time t18, the CPU 11 ends the startled reaction gesture.

Even when an external stimulus occurs while the robot 1 is performing a gesture, depending on the relation between the external stimulus and the currently performed gesture, the CPU 11 does not cause the robot 1 to perform processing (reaction gesture) corresponding to the external stimulus. In such a case, the CPU 11 causes the robot 1 to complete the currently performed gesture and disables execution of processing corresponding to the external stimulus. In other words, the robot 1 behaves as if it has received no external stimuli.

As explained above, the robot control device 10 according to this embodiment includes the CPU 11 that controls the robot 1. The robot 1 includes sensors that detect external stimuli (e.g., the touch sensor 51, the acceleration sensor 52, the gyro sensor 53, the illuminance sensor 54, and the microphone 55). In causing the robot 1 to perform processing corresponding to an external stimulus, the CPU 11 may not cause the robot 1 to perform the processing corresponding to the external stimulus, depending on the type of gesture being performed by the robot 1. Thus, the CPU 11 can avoid wrong detection of external stimuli unintended by the user and reduce unnatural motions of the robot 1. Accordingly, the robot 1 can appropriately respond to user operations.

If the robot uniformly performs reaction motions in response to external stimuli, the motions may seem unnatural depending on the situation of the robot. For example, if the sensor detects contact or sound in surroundings originated from the robot's own motions (gestures), the robot may make unnatural reactions.

According to the present disclosure, the robot can avoid such unnatural motions.

For example, in a case where the CPU 11 does not allow the robot 1 to execute processing corresponding to an external stimulus, the CPU 11 disables execution of processing corresponding to the external stimulus detected by a sensor (e.g., the sensor unit 50). Thus, the CPU 11 can prevent unnatural motions of the robot 1.

Further, the CPU 11 determines whether to cause the robot 1 to execute processing corresponding to an external stimulus, based on a group to which the external stimulus belongs. Thus, the CPU 11 can easily distinguish between external stimuli intended by the user and unintended external stimuli.

Further, when the robot 1 is performing a spontaneous gesture, the CPU 11 may cause the robot 1 to execute processing corresponding to an external stimulus. On the other hand, when the robot 1 is performing a gesture other than the spontaneous gestures, the CPU 11 may not cause the robot 1 to execute processing corresponding to an external stimulus. When the robot 1 is performing a gesture other than the spontaneous gestures, the robot 1 is making a relatively large amount of motions. Therefore, the CPU 11 may determine the sensor signals originated from the robot 1's own gestures to be specific external stimuli. By preventing the robot 1 from executing processing corresponding to external stimuli, the CPU 11 can prevent reaction gestures of the robot 1 unintended by the user. In particular, the CPU 11 determines whether to cause the robot 1 to execute processing corresponding to external stimuli, depending on whether the gesture currently performed by the robot 1 is the breathing gesture. Thus, the CPU 11 can prevent the robot 1 from performing unnatural motions.

Further, according to this embodiment, the robot 1 includes the robot control device 10 and sensors (the touch sensors 51, the acceleration sensor 52, the gyro sensor 53, the illuminance sensor 54, and the microphone 55). Such a robot 1 can avoid wrongly detecting external stimuli unintended by the user and can perform natural motions. Further, according to the method of controlling the robot 1 of this embodiment, or according to the program 131 of this embodiment executed by the CPU 11, false detection of external stimuli unintended by the user can be prevented, and unnatural motions by the robot 1 can be prevented.

The above embodiment is not intended to limit the present disclosure and can be variously modified. In the above embodiment, the CPU 11 disables the robot 1 to execute processing (reaction gesture) corresponding to an external stimulus detected by a sensor (the sensor unit 50), based on the type of gesture being performed by the robot 1, as an example of not allowing the robot 1 to execute processing corresponding to an external stimulus detected by a sensor. Alternatively, the CPU 11 may stop the sensor (e.g., the sensor unit 50) from detecting external stimuli and thereby prevent the robot 1 from performing processing corresponding to external stimuli. Thus, the CPU 11 can prevent unnatural motions of the robot 1. Further, the CPU 11 may decrease detection sensitivity of external stimuli by the sensor (e.g., the sensor unit 50) and thereby prevent the robot 1 from performing processing corresponding to external stimuli. The detection sensitivity of external stimuli is decreased by, for example, changing a threshold for detecting external stimuli. Thus, the CPU 11 can prevent unnatural motions of the robot 1.

Further, emotion parameters regarding the robot 1's emotions, character parameters regarding the robot 1's character, and/or growth parameters regarding the robot 1's growth may be stored in the storage 13 and frequently/regularly updated; and the robot 1 may be operated according to the values of the emotion parameters, the character parameters, and/or the growth parameters. The method described in JP 2022-142107, for example, may be used for controlling the motions of the robot 1 according to the parameters.

The configuration of the robot 1 is not limited to the example illustrated in FIG. 1 to FIG. 3. For example, the robot 1 may be a robot imitating a real creature, such as a human being, an animal, a bird, or a fish; or a robot imitating a non-existent creature, such as a dinosaur; or a robot representing an imaginary creature.

In the above embodiment, although the robot control device 10 that controls the robot 1 is provided inside the robot 1, the present disclosure is not limited to this. The robot 1 may be controlled and operated by an external robot control device provided outside the robot 1. The external robot control device may be a smartphone, tablet device, or laptop computer, for example. In such a case, the robot 1 operates in accordance with control signals from the external robot control device received via the communication unit 60. The external robot control device performs the functions performed by the robot control device 10 in the above embodiment.

In the above description, the nonvolatile memory of the storage 13 is used as an example of a computer-readable medium that stores the program according to the present disclosure. However, the present disclosure is not limited to this example. As other computer-readable media, an information recording medium such as a hard disk drive (HDD), a solid state drive (SDD), or a CD-ROM can be applied, for example.

Further, a carrier wave may be used as a medium to provide data of the program of the present disclosure via a communication line.

The detailed configuration and detailed operations of the components constituting the robot 1 in the above embodiment can be appropriately modified without departing from the scope of the present disclosure. Although some embodiments of the present disclosure have been described, the scope of the present disclosure is not limited to the embodiments described above but encompasses the scope of the invention recited in the claims and the equivalent thereof.

1. A robot control device comprising one or more processors configured to:
cause a robot to perform processing corresponding to an external stimulus detected by a sensor, and
(i) disable the robot from performing processing corresponding to the external stimulus detected by the sensor, (ii) stop the sensor from detecting the external stimulus, or (iii) decrease a detection sensitivity of the external stimulus by the sensor, depending on a type of a gesture being currently performed by the robot.

2. The robot control device according to claim 1, wherein the one or more processors determine whether to cause the robot to perform processing corresponding to the external stimulus, based on a group to which the external stimulus belongs.

3. The robot control device according to claim 1, wherein:
in a case where a predetermined condition is met, the one or more processors cause the robot to perform a spontaneous gesture that does not depend on the external stimulus,
in a case where the gesture being currently performed by the robot is the spontaneous gesture, the one or more processors cause the robot to perform processing corresponding to the external stimulus, and
in a case where the gesture being currently performed by the robot is not the spontaneous gesture, the one or more processors do not cause the robot to perform processing corresponding to the external stimulus.

4. The robot control device according to claim 3, wherein the spontaneous gesture is a gesture imitating breathing.

5. A robot comprising:
the robot control device according to claim 1; and
the sensor.

6. A robot control method of causing a robot to perform processing corresponding an external stimulus detected by a sensor,
wherein, depending on a type of a gesture being currently performed by the robot,
(i) the robot is disabled from performing processing corresponding to the external stimulus detected by the sensor,
(ii) the sensor is stopped from detecting the external stimulus, or
(iii) a detection sensitivity of the external stimulus by the sensor is decreased.
